(19) United States
(12) Patent Application Publication
(10) Pub. No.: US 2018/0182325 A1
(43) Pub. Date: Jun. 28, 2018

(54) DRIVING METHOD FOR LIQUID CRYSTAL PANEL AND DRIVING DEVICE OF THE SAME

(71) Applicant: Shenzhen China Star Optoelectronics Technology Co., Ltd., Shenzhen, Guangdong (CN)

(72) Inventor: Zhi XIONG, Shenzhen, Guangdong (CN)

(73) Assignee: Shenzhen China Star Optoelectronics Technology Co., Ltd., Shenzhen, Guangdong (CN)

(21) Appl. No.: 15/311,505

(22) PCT Filed: Aug. 10, 2016
(86) PCT No.: PCT/CN2016/094377

§ 371 Date: Nov. 15, 2016

(30) Foreign Application Priority Data
Jun. 7, 2016 (CN) 201610397760.X

(51) Int. Cl. G09G 3/36

(52) U.S. Cl. CPC G09G 3/3614; G09G 2320/0295; G09G 2320/0257; G09G 2320/0247

(57) ABSTRACT

A driving method for a liquid crystal panel and a driving device are disclosed. The driving method comprises steps of: A) determining a current inversion driving method of a liquid crystal panel; B) performing a predetermined calculation to grayscale levels of all pixels of an image to be displayed of the liquid crystal panel according to the current inversion driving method; and C) when a result value of the predetermined calculation is greater than a predetermined value, changing the current inversion driving method. According to the exemplary embodiment of the present invention, the flicker problem when the liquid crystal panel statically displays an image can be improved.

### BACKGROUND OF THE INVENTION

### 1. Field of the Invention

The present invention relates to a liquid crystal display technology field, and more particularly to a driving method for a liquid crystal panel and a driving device of the same.

### 2. Description of Related Art

Because of the characteristic of the liquid crystal molecules themselves, when using a direct-current voltage to drive the liquid crystal molecules in a liquid crystal display (LCD) to be deflected, a polar electric field is easily generated by the polar molecule in the liquid crystal material in order to generate a constant direct-current bias voltage so as to cause an image-sticking phenomenon. For the phenomenon, the industry usually adopts an inversion driving method that positive and negative polarities are inverted to improve the phenomenon. However, when adopting a fixed inversion driving method to drive a liquid crystal panel, and the liquid crystal panel statically displays an image, a flicker problem caused by the brightness changing continuously is occurred.

As shown in FIG. 1, which shows a schematic diagram of flicker when adopting a column inversion method to display an image. For helping to understand, a displayed image only has two grayscale levels, respectively 0 and 127, odd columns show the grayscale level of 127, and even columns show the grayscale level of 0. Besides, the column inversion method performs a polarity inversion using one column as one unit between an N-th frame and a (N+3)-th frame. At the N-th frame, driving voltages for pixels having 127 grayscale level are all positive polarities, driving voltages for pixels having 0 grayscale level are all negative polarities. At a (N+1)-th frame, driving voltages for pixels having 127 grayscale level are all negative polarities, driving voltages for pixels having 0 grayscale level are all positive polarities, and repeated in a (N+2)-th frame and the (N+3)-th frame to display. Using pixels having 127 grayscale level as an example, because an average value of a positive polarity driving voltage and a negative polarity driving voltage fully consistent with a VCOM (reference voltage) cannot be guaranteed such that an absolute value of voltage difference between the positive polarity driving voltage and the VCOM and an absolute value of voltage difference between the negative polarity driving voltage and the VCOM are inconsistent so that brightnesses of the pixels having a same grayscale level under the positive polarity driving voltage and the negative polarity driving voltage are inconsistent as well. Similarly, brightnesses of the pixels having 0 grayscale level under the positive polarity driving voltage and the negative polarity driving voltage are inconsistent. That is, when displaying an image, in the process of switching from the N-th frame to the (N+1)-th frame, from the (N+1)-th frame to the (N+2)-th frame, and from (N+2)-th frame to (N+3)-th frame, a brightness of a pixel of each grayscale level is changed. Accordingly, a human eye will feel that the displayed picture is flicker.

As shown in FIG. 2, which shows a schematic diagram of flicker when adopting a two-row inversion method to display an image. The displayed image only has two grayscale levels, respectively 0 and 127, and using two rows as one group. The pixels in odd columns and odd groups display 127 grayscale level, and pixels in odd columns and even groups display 0 grayscale level.

Besides, the two-row inversion driving method performs a polarity inversion between an N-th frame and a (N+3)-th frame. At the N-th frame, driving voltages for pixels having 127 grayscale level are all positive polarities, driving voltages for pixels having 0 grayscale level are all negative polarities. At a (N+1)-th frame, driving voltages for pixels having 127 grayscale level are all negative polarities, driving voltages for pixels having 0 grayscale level are all positive polarities, and repeated in a (N+2)-th frame and the (N+3)-th frame to display. At this time, based on the reason discussed above, when display a picture, in the process of switching from the N-th frame to the (N+1)-th frame, from the (N+1)-th frame to the (N+2)-th frame, and from (N+2)-th frame to (N+3)-th frame, a brightness of a pixel of each grayscale level is changed. Accordingly, a human eye will feel that the displayed image is flicker.

### SUMMARY OF THE INVENTION

In order to overcome the drawbacks of the conventional art, the embodiment of the present invention provides a driving method for a liquid crystal panel and a driving device for the same that can improve the flicker problem when the liquid crystal panel statically displays an image.

According to an embodiment of the present invention, in one aspect, the present invention provides a driving method for a liquid crystal panel, wherein, the driving method comprises steps of: A) determining a current inversion driving method of a liquid crystal panel; B) performing a predetermined calculation to grayscale levels of all pixels of an image to be displayed of the liquid crystal panel according to the current inversion driving method; and C) when a result value of the predetermined calculation is greater than a predetermined value, changing the current inversion driving method.

Optionally, in the step B): calculating an absolute value of a sum of the grayscale levels of all pixels having a first polarity in the image to be displayed minus a sum of the grayscale levels of all pixels having a second polarity in the image to be displayed, when the image to be displayed is driven by the current inversion driving method.

Optionally, when the current inversion driving method is a column inversion driving method, in the step B): calculating an absolute value of a sum of the grayscale levels of all pixels located at odd columns in the image to be displayed minus a sum of the grayscale levels of all pixels located at even columns in the image to be displayed.

Optionally, when the current inversion driving method is a two-row inversion driving method, the step B) comprises: grouping without repetition the grayscale levels of all pixels of the image to be displayed from top to bottom and adopting two adjacent rows as one group; and calculating an absolute value of a sum of the grayscale levels of all pixels at odd columns of odd groups minus a sum of the grayscale levels of all pixels at even columns of even groups; wherein, when the number of the rows of all pixels of the image to be displayed in an odd, the bottom row forms one group.

Optionally, in the step C): if the current inversion driving method is a column inversion driving method, and the result value of the predetermined calculation is greater than the predetermined value, the current inversion driving method is changed to a two-row inversion driving method; or, if the current inversion driving method is a two-row inversion driving method, when the result value of the predetermined calculation is greater than the predetermined value, the current inversion driving method can be changed to a column inversion driving method.

According to an embodiment of the present invention, in another aspect, the present invention provides a driving device for a liquid crystal panel, wherein, the driving device comprises: a driving determining unit, used for determining a current inversion driving method of a liquid crystal panel; a calculation unit, used for performing a predetermined calculation to grayscale levels of all pixels of an image to be displayed of the liquid crystal panel according to the current inversion driving method; and a driving changing unit, used for changing the current inversion driving method when a result value of the predetermined calculation is greater than a predetermined value.

Optionally, the calculation unit calculates an absolute value of a sum of the grayscale levels of all pixels having a first polarity in the image to be displayed minus a sum of the grayscale levels of all pixels having a second polarity in the image to be displayed, when the image to be displayed is driven by the current inversion driving method.

Optionally, when the current inversion driving method is a column inversion driving method, the calculation unit calculates an absolute value of a sum of the grayscale levels of all pixels located at odd columns in the image to be displayed minus a sum of the grayscale levels of all pixels located at even columns in the image to be displayed.

Optionally, when the current inversion driving method is a two-row inversion driving method, the calculation unit comprises: a grouping sub-unit, used for grouping without repetition the grayscale levels of all pixels of the image to be displayed from top to bottom and adopting two adjacent rows as one group; and a calculation sub-unit, used for calculating an absolute value of a sum of the grayscale levels of all pixels at odd columns of odd groups minus a sum of the grayscale levels of all pixels at even columns of even groups; wherein, when the number of the rows of all pixels of the image to be displayed in an odd, the bottom row forms one group.

Optionally, if the current inversion driving method is a column inversion driving method, the driving changing unit changes the current inversion driving method to a two-row inversion driving method when the result value of the predetermined calculation is greater than the predetermined value; or, if the current inversion driving method is a two-row inversion driving method, the driving changing unit changes the current inversion driving method to a column inversion driving method when the result value of the predetermined calculation is greater than the predetermined value.

According to the exemplary embodiment of the present invention, the flicker problem when the liquid crystal panel statically displays an image can be improved.

The following description will illustrate another aspect and/or advantages of the present invention, another portion of the present invention will be clear, or can be understood through the embodiment of the present invention.

### BRIEF DESCRIPTION OF THE DRAWINGS

The following content will combine figures for illustrating the embodiments of the present invention, the above purpose and/or the other purpose and advantages of the present invention will become clearer, wherein:

FIG. 1 is a schematic diagram of flicker when adopting a column inversion driving method to display an image;

FIG. 2 is a schematic diagram of flicker when adopting a two-row inversion driving method to display an image;

FIG. 3 is a flow chart of a driving method of a liquid crystal panel according to an embodiment of the present invention;

FIG. 4 is a flow chart of a calculation method of performing a predetermined calculation when using a two-row driving method to drive an image to be displayed according to an embodiment of the present invention;

FIG. 5 is a schematic diagram of changing a column inversion driving method to a two-row inversion driving method for FIG. 1;

FIG. 6 is a schematic diagram of changing a two-row inversion driving method to a column inversion driving method for FIG. 2;

FIG. 7 is a block diagram of a driving device of the liquid crystal panel according to an embodiment of the present invention; and

FIG. 8 is a block diagram of a calculation unit when using a two-row inversion driving method to drive an image to be displayed according to an embodiment of the present invention.

### DETAILED DESCRIPTION OF THE PREFERRED EMBODIMENT

Now, the exemplary example of the present invention will be described in detail. The examples of the embodiments are shown in the figures, wherein, a same numeral indicates a same part. The following will refer to the figures to illustrate the embodiments in order to explain the present invention.

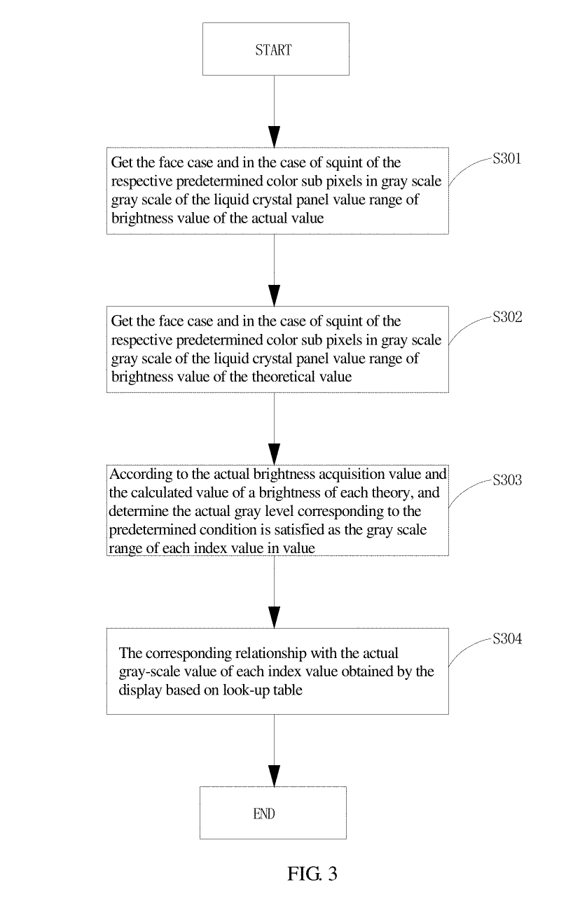

FIG. 3 is a flow chart of a driving method of a liquid crystal panel according to an embodiment of the present invention.

As shown in FIG. 3, in a step S100, determining a current inversion driving method of a liquid crystal panel. Here, the inversion driving method can be various inversion driving methods used in the conventional art. Specifically, including: a column inversion driving method, a row inversion driving method, a dot inversion driving method, a two-row inversion driving method, a two-column inversion driving method, and a frame inversion driving method.

It can be understood that the current inversion driving method of the liquid crystal panel can be determined through various methods in the conventional art. For example, the current inversion driving method is determined through reading data stored at preset locations for setting the current inversion driving method.

In a step S200, performing a predetermined calculation to grayscale levels of all pixels of an image to be displayed of the liquid crystal panel according to the current inversion driving method determined in the step S100. Here, the calculation method of the predetermined calculation can be determined according to parameters of the liquid crystal panel and some experiments.

Preferably, in the step S200, calculating an absolute value of a sum of the grayscale levels of all pixels having a first polarity in the image to be displayed minus a sum of the grayscale levels of all pixels having a second polarity in the image to be displayed, when the image to be displayed is driven by the current inversion driving method. Here, the image to be displayed is an image that will be displayed after a current displayed image, and is different from the current displayed image. The first polarity is one of the positive polarity and the negative polarity. The second polarity is a polarity that is one of the positive polarity and the negative polarity and is different from the first polarity. That is, when the image to be displayed is driven by the current inversion driving method, one portion of the pixels in the image to be displayed have positive polarities, and the other portion of the pixels in the image to be displayed have negative polarities. Here, an absolute value of a sum of the grayscale levels of all pixels having positive or negative polarities in the image to be displayed minus a sum of the grayscale levels of all pixels having negative or positive polarities in the image to be displayed is calculated.

The following content, using a column inversion driving method and a two-row inversion driving method as a preferred embodiment for illustrating the specific calculation method of the step S200.

The column inversion driving method is shown in FIG. 1, between the N-th frame and the (N+3)-th frame, using one column as one unit to perform the inversion of the polarity.

By this way, when using a column inversion driving method to drive the image to be displayed, in the step S200, calculating an absolute value of a sum of the grayscale levels of all pixels located at odd columns in the image to be displayed minus a sum of the grayscale levels of all pixels located at even columns in the image to be displayed. As shown in FIG. 1, at the N-the frame, the first polarity is a positive polarity, and the second polarity is a negative polarity. At the (N+1)-th frame, the polarities are inverted, but the calculation result is the same. The other driving methods are the same as above, no more repeating.

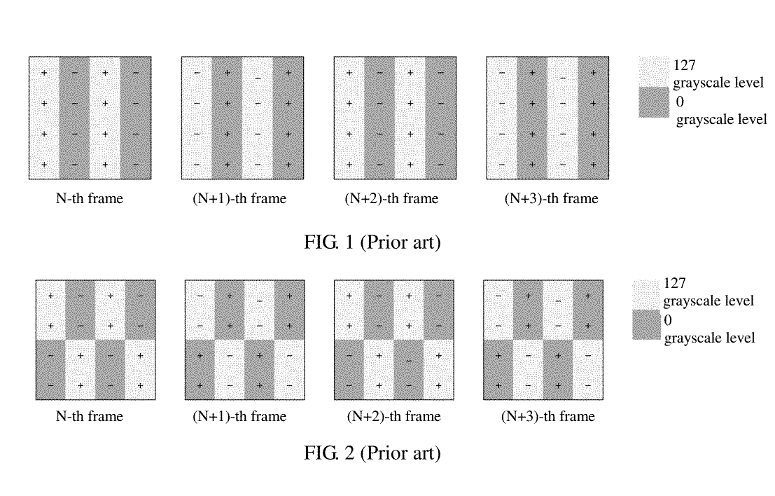

The two-row inversion driving method is shown in FIG. 2, between the N-th frame and the (N+3)-th frame, in each column, using two rows as one unit to invert the polarities.

By this way, when using the two-row inversion driving method to drive the image to be displayed, the step S200 can perform the predetermined calculation through the calculation method shown in FIG. 4.

FIG. 4 is a flow chart of the calculation method when using two-row inversion driving method to drive the image to be displayed to perform a predetermined calculation according to an exemplary embodiment of the present invention.

As shown in FIG. 4, in a step S210, grouping without repetition the grayscale levels of all pixels of the image to be displayed from top to bottom and adopting two adjacent rows as one group.

In a step S220, calculating an absolute value of a sum of the grayscale levels of all pixels at odd columns of odd groups minus a sum of the grayscale levels of all pixels at even columns of even groups.

Here, the above calculation method is a situation when the number of the rows of all pixels of the image to be displayed is an even. When the number of the rows of all pixels of the image to be displayed in an odd, the bottom row can be one group in order to perform a predetermined calculation.

In the above, although two preferred embodiments are adopted to illustrate the calculation method of the step S200, however, the calculation method of the step S200 is not limited. The only requirement is to obtain an absolute value of a sum of the grayscale levels of all pixels having a first polarity in the image to be displayed minus a sum of the grayscale levels of all pixels having a second polarity in the image to be displayed through the step S200, any calculation method can be adopted.

For example, in the above two-row inversion driving method, grouping without repetition the grayscale levels of all pixels is performed first, then, performing a subsequent calculation. However, the step of grouping is not a necessary step and can be omitted according to the inversion driving method to flexibility adjust each step, the only requirement is to obtain an absolute value of a sum of the grayscale levels of all pixels having a first polarity in the image to be displayed minus a sum of the grayscale levels of all pixels having a second polarity in the image to be displayed.

In a step S300, when a result value of the predetermined calculation in the step S200 is greater than a predetermined value, changing the current inversion driving method. Here, the predetermined value can be defined through an experiment.

For example, in the step S300, preferably, when the current inversion driving method is a column inversion driving method, and the result value of the predetermined calculation is greater than the predetermined value, the current inversion driving method is changed to a two-row inversion driving method. Or, if the current inversion driving method is a two-row inversion driving method, when the result value of the predetermined calculation is greater than the predetermined value, the current inversion driving method can be changed to a column inversion driving method.

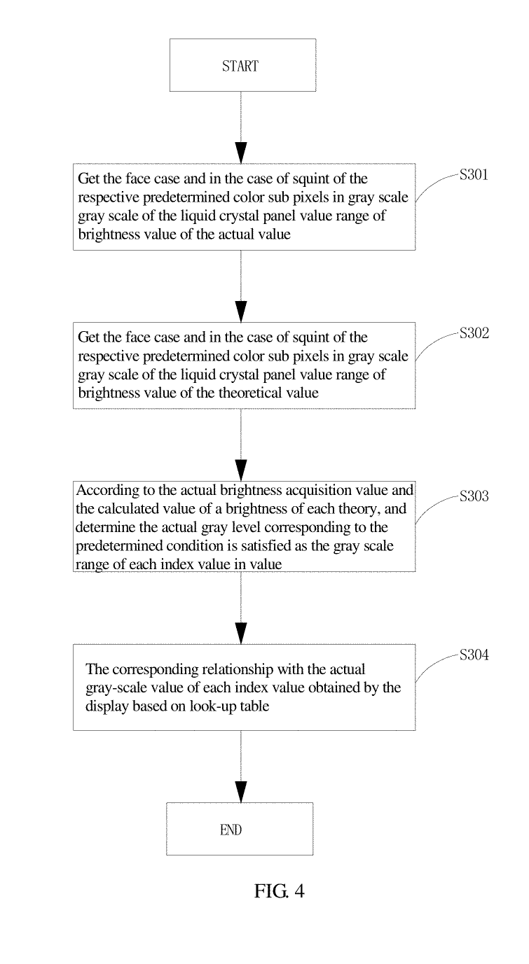

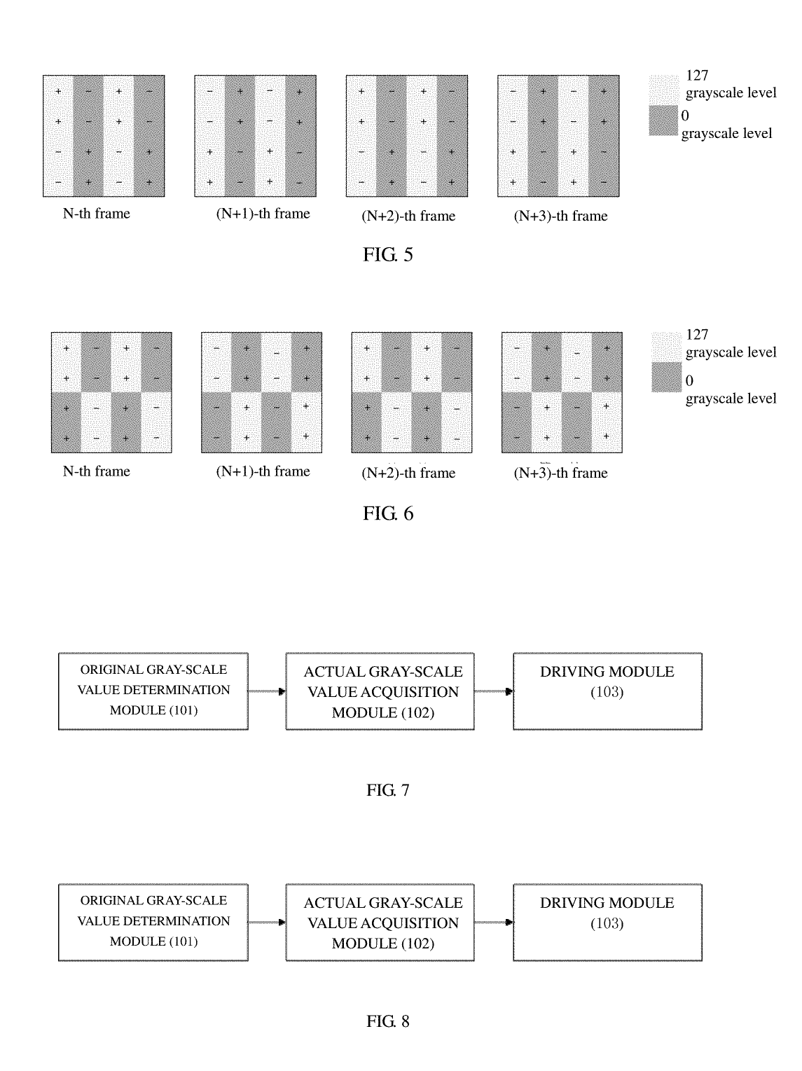

FIG. 5 shows a schematic diagram of changing the column inversion driving method shown in FIG. 1 to a two-row inversion driving method. As shown in FIG. 5, a displayed image is unchanged, and changing the column inversion driving method to a two-row inversion driving method.

FIG. 6 is a schematic diagram of changing the two-row inversion driving method shown in FIG. 2 to a column inversion driving method. As shown in FIG. 6, the displayed image is unchanged, and changing the two-row inversion driving method to a column inversion driving method.

It should be noted that the present invention is not limited to only two grayscale levels shown in FIG. 5 and FIG. 6, and can be various images having various grayscale levels.

In the step S300, through changing the current inversion driving method to improve the flicker problem when the liquid crystal panel statically displays an image. Accordingly, in the step S300, the changing of the inversion driving method can be targeted or random, and can be determined by a suitable inversion driving method of the image to be displayed, that is, each static image to be displayed has a most suitable inversion driving method. Therefore, the changing of the present embodiment is not limited to switching between the column inversion driving method and the two-row inversion driving method, and can be applied in the switching of any two inversion driving method between the column inversion driving method, the row inversion driving method, the dot inversion driving method, the two-row inversion driving method, the two-column inversion driving method and the frame inversion driving method. Besides, when changing the inversion driving method, the current inversion driving method can be changed to a combination of two or above of the above inversion driving methods. That is, the only requirement is to decrease the flicker problem when the liquid crystal panel statically displays an image to be displayed.

According to the driving method of the liquid crystal panel of the exemplary embodiments of the present invention, no matter what kind of inversion driving method of the liquid crystal panel is, the flicker problem when the liquid crystal panel statically displays the image to be displayed can be improved through the above driving method to dynamically change the current inversion driving method.

FIG. 7 is a block diagram of a driving device of a liquid crystal panel according to an exemplary embodiment of the present invention.

As shown in FIG. 7, a driving device 10 includes: a driving determining unit 100, a calculation unit 200 and a driving changing unit 300.

The driving determining unit 100 is used for determining the current inversion driving method. Here, the inversion driving method can be various driving methods in the conventional art, specifically including: a column inversion driving method, a row inversion driving method, a dot inversion driving method, a two-row inversion driving method, a two-column inversion driving method, and a frame inversion driving method.

It can be understood that the driving determining unit 100 can determine the current inversion driving method of the liquid crystal panel through various conventional method. For example, the driving determining unit 100 can determine the current inversion driving method through reading the data for setting the inversion driving method stored at a preset location.

The calculation unit 200 performs a predetermined calculation to grayscale levels of all pixels of an image to be displayed of the liquid crystal panel according to the current inversion driving method determined by the driving determining unit 100. Here, the calculation method of the predetermined calculation can be determined according to parameters of the liquid crystal panel and some experiments.

Preferably, the calculation unit 200 calculates an absolute value of a sum of the grayscale levels of all pixels having a first polarity in the image to be displayed minus a sum of the grayscale levels of all pixels having a second polarity in the image to be displayed, when the image to be displayed is driven by the current inversion driving method. Here, the image to be displayed is an image that will be displayed after a current displayed image, and is different from the current displayed image. The first polarity is one of the positive polarity and the negative polarity. The second polarity is a polarity that is one of the positive polarity and the negative polarity and is different from the first polarity. That is, the image to be displayed driven by the current inversion driving method, one portion of the pixels in the image to be displayed have positive polarities, and the other portion of the pixels in the image to be displayed have negative polarities. The calculation unit 200 is to calculate and obtain an absolute value of a sum of the grayscale levels of all pixels having positive or negative polarities in the image to be displayed minus a sum of the grayscale levels of all pixels having negative or positive polarities in the image to be displayed.

The following content, using a column inversion driving method and a two-row inversion driving method as a preferred embodiment for illustrating the specific constitution of the calculation unit 200.

Specifically, when using a column inversion driving method to drive the image to be displayed, the calculation unit 200 calculates an absolute value of a sum of the grayscale levels of all pixels located at odd columns in the image to be displayed minus a sum of the grayscale levels of all pixels located at even columns in the image to be displayed.

Besides, when using the two-row inversion driving method to drive the image to be displayed, the block diagram of the calculation unit 200 is as shown in FIG. 8.

FIG. 8 is a block diagram of a calculation unit when driving the image to be displayed in a two-row inversion driving method according to an exemplary embodiment of the present invention.

As shown in FIG. 8, the calculation unit 200 includes a grouping sub-unit 210 and a calculation sub-unit 220.

The grouping sub-unit 210 is used for grouping without repetition the grayscale levels of all pixels of the image to be displayed from top to bottom and adopting two adjacent rows as one group.

The calculation sub-unit 220 is used for calculating an absolute value of a sum of the grayscale levels of all pixels at odd columns of odd groups minus a sum of the grayscale levels of all pixels at even columns of even groups.

Here, the above grouping sub-unit 210 is a situation when the number of the rows of all pixels of the image to be displayed is an even. When the number of the rows of all pixels of the image to be displayed in an odd, the grouping sub-unit 210 can regard the bottom row as one group in order to perform a predetermined calculation through calculation sub-unit 220.

In the above, although two preferred embodiments are adopted to illustrate the calculation method of the calculation unit 200, however, the calculation unit 200 of the present invention is not limited. The only requirement is to obtain an absolute value of a sum of the grayscale levels of all pixels having a first polarity in the image to be displayed minus a sum of the grayscale levels of all pixels having a second polarity in the image to be displayed through the calculation unit 200, any structure can be adopted.

For example, in the above two-row inversion driving method, the calculation unit 200 including the grouping sub-unit 210 and the calculation sub-unit 220 is illustrated for an example. However, grouping sub-unit 210 is not a necessary sub-unit, and can be omitted. The constitution of the calculation unit 200 can be flexibility adjusted according to the inversion driving method, and the only requirement is that the calculation unit 200 can calculate and obtain an absolute value of a sum of the grayscale levels of all pixels having a first polarity in the image to be displayed minus a sum of the grayscale levels of all pixels having a second polarity in the image to be displayed.

The driving changing unit 300 changes the current inversion driving method when a result value of the predetermined calculation in the calculation unit 200 is greater than a predetermined value. Here, the predetermined value can be defined through an experiment.

For example, preferably, when the current inversion driving method is a column inversion driving method, and the driving changing unit 300 can change the current inversion driving method to a two-row inversion driving method when the result value of the predetermined calculation is greater than the predetermined value. Or, if the current inversion driving method is a two-row inversion driving method, when the result value of the predetermined calculation is greater than the predetermined value, the current inversion driving method can be changed to a column inversion driving method.

The driving changing unit 300, through changing the current inversion driving method to improve the flicker problem when the liquid crystal panel statically displays an image. Accordingly, for the driving changing unit 300, the changing of the inversion driving method can be targeted or random, and can be determined by a suitable inversion driving method of the image to be displayed, that is, each static image to be displayed has a most suitable inversion driving method. Therefore, the changing of the present embodiment is not limited to switching between the column inversion driving method and the two-row inversion driving method, and can be applied in the switching of any two inversion driving method between the column inversion driving method, the row inversion driving method, the dot inversion driving method, the two-row inversion driving method, the two-column inversion driving method and the frame inversion driving method. Besides, when changing the inversion driving method, the current inversion driving method can be changed to a combination of two or above of the above inversion driving methods. That is, the only requirement is to decrease the flicker problem when the liquid crystal panel statically displays an image to be displayed.

According to the driving device of the liquid crystal panel of the exemplary embodiments of the present invention, no matter what kind of inversion driving method of the liquid crystal panel is, the flicker problem when the liquid crystal panel statically displays the image to be displayed can be improved through the above driving method to dynamically change the current inversion driving method.

Besides, the driving method according to the embodiment of the present invention can be realized by computer codes in the computer readable recording medium. The person skilled in the art can realize the computer codes according to the description of the above driving methods. When the computer codes are executed in a computer, the above driving methods of the present invention can be realized.

Besides, each unit in the driving device of the liquid crystal panel of the embodiment of the present invention can be realized as a hardware component. The person skilled in the art can adopt the field-programmable gate array (FPGA) or the application-specific integrated circuit (ASIC) to realize each unit according to the process executed by each unit.

The above embodiments of the present invention are only exemplary, however, the present invention is not limited. The person skilled in the art can understand: without exceeding the principle and spirit of the present invention, the above embodiments can be improved, wherein, the scope of the present invention is limited in the claims and the equivalents of the claims.

What is claimed is:

1. A driving method for a liquid crystal panel, comprising steps of:
A) determining a current inversion driving method of a liquid crystal panel;
B) performing a predetermined calculation to grayscale levels of all pixels of an image to be displayed of the liquid crystal panel according to the current inversion driving method; and
C) when a result value of the predetermined calculation is greater than a predetermined value, changing the current inversion driving method.

2. The driving method according to claim 1, wherein, in the step B):
calculating an absolute value of a sum of the grayscale levels of all pixels having a first polarity in the image to be displayed minus a sum of the grayscale levels of all pixels having a second polarity in the image to be displayed, when the image to be displayed is driven by the current inversion driving method.

3. The driving method according to claim 2, wherein,
when the current inversion driving method is a column inversion driving method, in the step B): calculating an absolute value of a sum of the grayscale levels of all pixels located at odd columns in the image to be displayed minus a sum of the grayscale levels of all pixels located at even columns in the image to be displayed.

4. The driving method according to claim 2, wherein,
when the current inversion driving method is a two-row inversion driving method, the step B) comprises:
grouping without repetition the grayscale levels of all pixels of the image to be displayed from top to bottom and adopting two adjacent rows as one group; and
calculating an absolute value of a sum of the grayscale levels of all pixels at odd columns of odd groups minus a sum of the grayscale levels of all pixels at even columns of even groups;
wherein, when the number of the rows of all pixels of the image to be displayed in an odd, the bottom row forms one group.

5. The driving method according to claim 1, wherein, in the step C):
if the current inversion driving method is a column inversion driving method, and the result value of the predetermined calculation is greater than the predetermined value, the current inversion driving method is changed to a two-row inversion driving method;
or, if the current inversion driving method is a two-row inversion driving method, when the result value of the predetermined calculation is greater than the predetermined value, the current inversion driving method can be changed to a column inversion driving method.

6. A driving device for a liquid crystal panel, comprising:
a driving determining unit, used for determining a current inversion driving method of a liquid crystal panel;
a calculation unit, used for performing a predetermined calculation to grayscale levels of all pixels of an image to be displayed of the liquid crystal panel according to the current inversion driving method; and
a driving changing unit, used for changing the current inversion driving method when a result value of the predetermined calculation is greater than a predetermined value.

7. The driving device according to claim 6, wherein, the calculation unit calculates an absolute value of a sum of the grayscale levels of all pixels having a first polarity in the image to be displayed minus a sum of the grayscale levels of all pixels having a second polarity in the image to be displayed, when the image to be displayed is driven by the current inversion driving method.

8. The driving device according to claim 7, wherein,
when the current inversion driving method is a column inversion driving method, the calculation unit calculates an absolute value of a sum of the grayscale levels of all pixels located at odd columns in the image to be displayed minus a sum of the grayscale levels of all pixels located at even columns in the image to be displayed.

9. The driving device according to claim 7, wherein,
when the current inversion driving method is a two-row inversion driving method, the calculation unit comprises:
a grouping sub-unit, used for grouping without repetition the grayscale levels of all pixels of the image to be displayed from top to bottom and adopting two adjacent rows as one group; and
a calculation sub-unit, used for calculating an absolute value of a sum of the grayscale levels of all pixels at odd columns of odd groups minus a sum of the grayscale levels of all pixels at even columns of even groups;
wherein, when the number of the rows of all pixels of the image to be displayed in an odd, the bottom row forms one group.

10. The driving device according to claim 6, wherein,
if the current inversion driving method is a column inversion driving method, the driving changing unit changes the current inversion driving method to a two-row inversion driving method when the result value of the predetermined calculation is greater than the predetermined value;
or, if the current inversion driving method is a two-row inversion driving method, the driving changing unit changes the current inversion driving method to a column inversion driving method when the result value of the predetermined calculation is greater than the predetermined value.
